(19) United States
(12) Patent Application Publication
(10) Pub. No.: US 2024/0163977 A1
(43) Pub. Date: May 16, 2024

(54) WIRING SHEET FOR THREE-DIMENSIONAL MOLDING

(71) Applicant: LINTEC Corporation, Tokyo (JP)

(72) Inventors: Tatsuki HASEGAWA, Tokyo (JP); Masaharu ITO, Tokyo (JP); Takashi MORIOKA, Tokyo (JP)

(73) Assignee: LINTEC Corporation, Tokyo (JP)

(21) Appl. No.: 18/283,692

(22) PCT Filed: Mar. 4, 2022
(86) PCT No.: PCT/JP2022/009363

§ 371 Date: Sep. 22, 2023

(30) Foreign Application Priority Data
Mar. 23, 2021 (JP) 2021-048105

(51) Int. Cl. H05B 3/28

(52) U.S. Cl. CPC H05B 3/286; H05B 2203/003

(57) ABSTRACT

A wiring sheet for three-dimensional molding includes a pseudo-sheet structure including a plurality of conductive linear bodies arranged at an interval; a first embedding layer; and a second embedding layer, the pseudo-sheet structure being sandwiched between the first embedding layer and the second embedding layer. The conductive linear bodies have a wave shape when viewed from above. A storage shear modulus at 23° C. of each of the first embedding layer and the second embedding layer is from 1×10⁴ to 3×10⁶ Pa. When a thickness of the first embedding layer is T₁, a thickness of the second embedding layer is T₂, and a thickness of the pseudo-sheet structure is T₃, a specific relational equation is satisfied.

### TECHNICAL FIELD

The present disclosure relates to a wiring sheet for three-dimensional molding.

### BACKGROUND ART

In recent years, proposals have been made for using, as a heat-generating element of a heat generator, a conductive structure obtained by fixing a conductive member such as metal wire or the like to a support body.

For example, Patent Literature 1 describes a sheet (hereinafter also referred to as “wiring sheet”) having a pseudo-sheet structure obtained by arranging, at an interval, a plurality of linear bodies that extend in one direction.

Additionally, three-dimensional molding methods such as three-dimension overlay method (TOM) molding, film insert molding, vacuum forming, and the like are known as techniques for imparting functions such as design, scratch resistance, and the like to the surface of a molded object to be used in home electronics housings, vehicle interior parts, construction interior parts, and the like (for example, see Patent Literature 2).

### CITATION LIST

### Patent Literature

Patent Literature 1: International Publication No. WO 2017/086395 (US2018/0326697A1)

Patent Literature 2: Unexamined Japanese Patent Application Publication No. 2015-182438

### SUMMARY OF INVENTION

### Technical Problem

In the related art, when performing three-dimensional molding processing on a wiring sheet such as that described in Patent Literature 1, there are cases in which the linear bodies or the like move during the processing, which leads to cavities being produced around the linear bodies or the like, and appearance defects problems occurring.

The present disclosure is made with the view of the above situation, and an objective of the present disclosure is to provide a wiring sheet in which appearance defect problems are less likely to occur after three-dimensional molding processing.

### Solution to Problem

To achieve the objective described above, the present inventors diligently studied a wiring sheet including a pseudo-sheet structure constituted by a plurality of conductive linear bodies.

As a result of these studies, the present inventors found that appearance defect problems are less likely to occur after three-dimensional molding processing in a wiring sheet for three-dimensional molding including a pseudo-sheet structure, a first embedding layer, and a second embedding layer, the pseudo-sheet structure being sandwiched between the first embedding layer and the second embedding layer, wherein a storage shear modulus of the first embedding layer and the second embedding layer is within a specific range and, also, specific requirements related to a thickness of the first embedding layer, a thickness of the second embedding layer, and a thickness of the pseudo-sheet structure are satisfied. The present inventors arrived at the present disclosure on the basis of these findings.

Thus, according to the present disclosure, the wiring sheet for three-dimensional molding of [1] to [6] below is provided.
[1] A wiring sheet for three-dimensional molding including: a pseudo-sheet structure that includes a plurality of conductive linear bodies arranged at an interval; a first embedding layer; and a second embedding layer, the pseudo-sheet structure being sandwiched between the first embedding layer and the second embedding layer, wherein the conductive linear bodies have a wave shape when viewed from above, a storage shear modulus at 23° C. of each of the first embedding layer and the second embedding layer is from 1.0×10⁴ to 3.0×10⁶ Pa, and, when a thickness of the first embedding layer is T₁, a thickness of the second embedding layer is T₂, and a thickness of the pseudo-sheet structure is T₃, a following equation is satisfied:

1<(T₁+T₂)/T₃≤10 Equation 1
[2] The wiring sheet for three-dimensional molding according to [1], wherein a shape of a cross-section of each of the conductive linear bodies is a round shape having a diameter of 7 to 75 μm.
[3] The wiring sheet for three-dimensional molding according to [1] or [2], wherein the first embedding layer and the second embedding layer have identical compositions.
[4] The wiring sheet for three-dimensional molding according to any one of [1] to [3], wherein the first embedding layer and the second embedding layer are curable.
[5] The wiring sheet for three-dimensional molding according to any one of [1] to [4], further including at least one of a first resin layer adjacent to the first embedding layer and a second resin layer adjacent to the second embedding layer.
[6] The wiring sheet for three-dimensional molding according to [5], wherein at least one of a surface on a first embedding layer side of the first resin layer and a surface on a second embedding layer side of the second resin layer is releasable.

### Advantageous Effects of Invention

Accordingly to the present disclosure, a wiring sheet for three-dimensional molding is provided in which appearance defect problems are less likely to occur after three-dimensional molding processing.

### BRIEF DESCRIPTION OF DRAWINGS

FIG. 1 is a schematic perspective view of a wiring sheet for three-dimensional molding according to an embodiment of the present disclosure;

FIG. 2 is a schematic plan view of the wiring sheet for three-dimensional molding illustrated in FIG. 1;

FIG. 3 is a schematic perspective view of a wiring sheet for three-dimensional molding according to an embodiment of the present disclosure; and

FIG. 4 is a schematic perspective view of a wiring sheet for three-dimensional molding according to an embodiment of the present disclosure.

### DESCRIPTION OF EMBODIMENTS

A wiring sheet for three-dimensional molding of the present disclosure includes a pseudo-sheet structure that includes a plurality of conductive linear bodies arranged at an interval, a first embedding layer, and a second embedding layer, the pseudo-sheet structure being sandwiched between the first embedding layer and the second embedding layer. The conductive linear bodies have a wave shape when viewed from above. A storage shear modulus at 23° C. of each of the first embedding layer and the second embedding layer is from 1.0×10⁴ to 3.0×10⁶ Pa. When a thickness of the first embedding layer is T₁, a thickness of the second embedding layer is T₂, and a thickness of the pseudo-sheet structure is T₃, the following equation is satisfied:

1<(T₁+T₂)/T₃≤10 Equation 2

Hereinafter, the wiring sheet for three-dimensional molding of the present disclosure is described while referencing the drawings. It should be noted that, to facilitate description, some parts are illustrated on an enlarged scale or a reduced scale in the drawings.

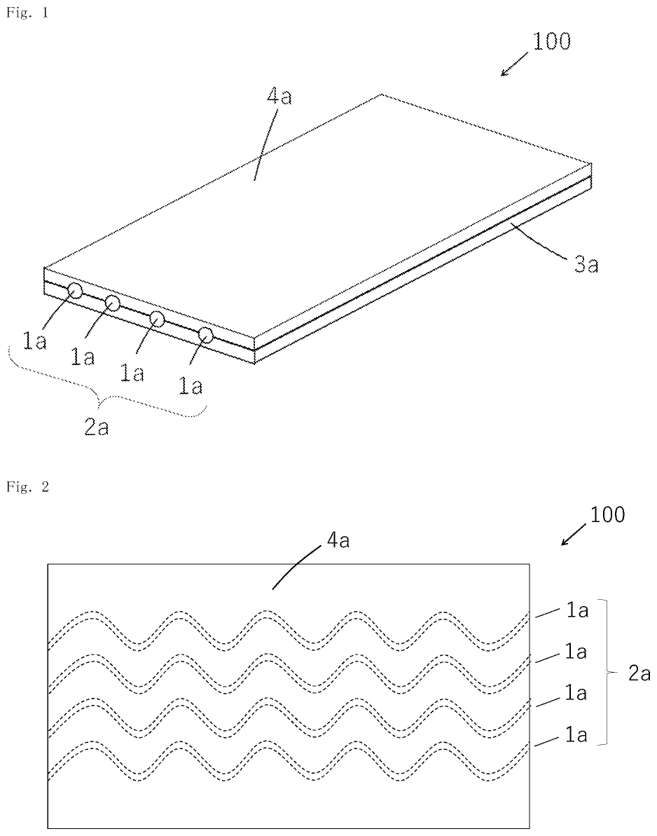

A wiring sheet for three-dimensional molding 100 illustrated in FIGS. 1 and 2 includes a pseudo-sheet structure 2a including a plurality (four) of conductive linear bodies 1a, a first embedding layer 3a, and a second embedding layer 4a. The pseudo-sheet structure 2a is sandwiched between the first embedding layer 3a and the second embedding layer 4a. The conductive linear bodies 1a have a wave shape when viewed from above.

The wiring sheet for three-dimensional molding may include a first resin layer adjacent to the first embedding layer and/or a second resin layer adjacent to the second embedding layer.

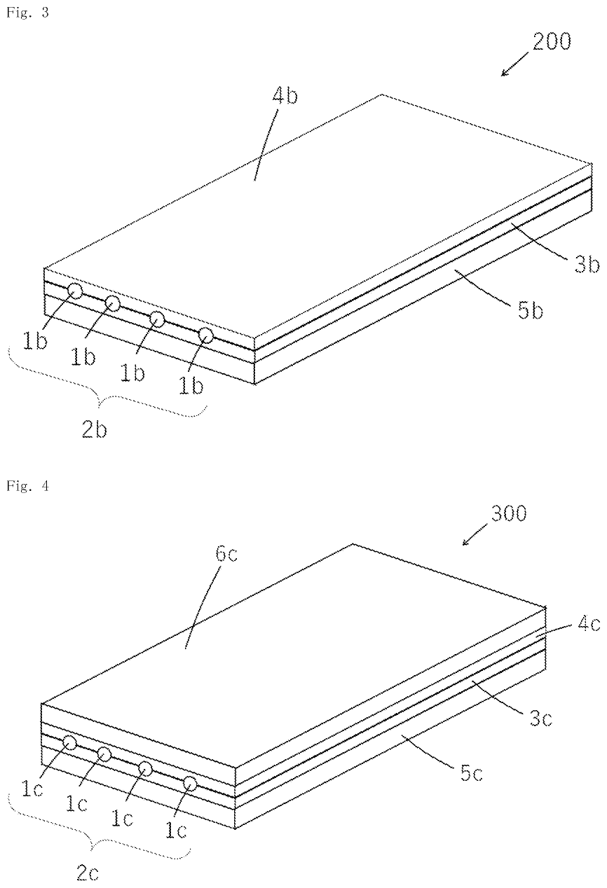

A wiring sheet for three-dimensional molding 200 illustrated in FIG. 3 includes a pseudo-sheet structure 2b including a plurality (four) of conductive linear bodies 1b, a first embedding layer 3b, and a second embedding layer 4b. The pseudo-sheet structure 2b is sandwiched between the first embedding layer 3b and the second embedding layer 4b. The wiring sheet for three-dimensional molding 200 further includes a first resin layer 5b adjacent to the first embedding layer 3b.

A wiring sheet for three-dimensional molding 300 illustrated in FIG. 4 includes a pseudo-sheet structure 2c including a plurality (four) of conductive linear bodies 1c, a first embedding layer 3c, and a second embedding layer 4c. The pseudo-sheet structure 2c is sandwiched between the first embedding layer 3c and the second embedding layer 4c. The wiring sheet for three-dimensional molding 300 further includes a first resin layer 5c adjacent to the first embedding layer 3c, and a second resin layer 6c adjacent to the second embedding layer 4c.

In the following, the various components of the wiring sheet for three-dimensional molding of the present disclosure are described.

### Conductive Linear Bodies

The conductive linear bodies of the wiring sheet for three-dimensional molding of the present disclosure are linear members that are electrically conductive. When the wiring sheet for three-dimensional molding of the present disclosure is a manufacturing material for a heat-generating element of a heat generator, the conductive linear bodies are members that generate heat.

The conductive linear bodies in the wiring sheet for three-dimensional molding of the present disclosure have a wave shape when viewed from above. Examples of the wave shape include a sine wave, a square wave, a triangle wave, a sawtooth wave, and the like.

The conductive linear bodies in the wiring sheet for three-dimensional molding of the present disclosure have a wave shape when viewed from above and, as such, the conductive linear bodies become linear when elongated at a time of three-dimensional molding, and the conductive linear bodies can elongate so as to conform to the elongation of the wiring sheet for three-dimensional molding. As such, with the wiring sheet for three-dimensional molding of the present disclosure, wire breakage and other problems are less likely to occur during three-dimensional molding processing.

A wavelength of the wave-shape conductive linear bodies is typically from 0.3 to 100 mm, and is preferably from 0.5 to 80 mm.

An amplitude of the wave-shape conductive linear bodies is typically from 0.3 to 200 mm, and is preferably from 0.5 to 160 mm.

The shape of a cross-section of each of the conductive linear bodies is not particularly limited. Examples of the shape of the cross-section of each of the conductive linear bodies include a circular shape, an elliptical shape, a flat shape, a polygonal shape, and the like. The circular shape is particularly preferable.

When the shape of the cross-section of each of the conductive linear bodies is a circular shape, a diameter of each of the conductive linear bodies is preferably from 7 to 75 μm, is more preferably from 8 to 60 μm, and is even more preferably from 12 to 40 μm.

Due to the cross-section of each of the conductive linear bodies being the circular shape having the diameter described above, the conductive linear bodies are provided with appropriate resistance, and heat generation efficiency thereof is enhanced.

The shape and the diameter of the cross-section of each of the conductive linear bodies can be ascertained by observing the conductive linear bodies using a digital microscope.

A volume resistivity of each of the conductive linear bodies is preferably from 1.0×10⁻⁹ to 1.0×10⁻³ Ω·m, and more preferably from 1.0×10⁻⁸ to 1.0×10⁻Ω·m.

A wiring sheet for three-dimensional molding suitable as a heat-generating element can be more easily obtained as a result of the volume resistivity of each of the conductive linear bodies being in these ranges.

The volume resistivity of each of the conductive linear bodies is a known value at 25° C., and is a value noted in Chemistry Handbook (Fundamentals) Revised 4th Edition (editor: The Chemical Society of Japan). Values of volume resistivity for alloys not noted in the Chemistry Handbook are disclosed by the manufacturers of those alloys.

Examples of the conductive linear bodies include a linear body including a metal wire, a linear body including a carbon nanotube, a linear body obtained by applying a conductive coating to string, and the like.

The linear body including a metal wire (hereinafter also referred to as “metal wire linear body”) may be a linear body formed from one metal wire, or may be a linear body obtained by twisting a plurality of metal wires. Additionally, the metal wire linear body may be a linear body that includes a core wire formed from a first metal, and a metal film that is provided on the outside of the core wire and that is made from a second metal different from the first metal.

Examples of the metal forming the metal wire include metals such as copper, aluminum, tungsten, iron, molybdenum, nickel, titanium, silver, gold, and the like; and alloys containing two or more metals (for example, steel such as stainless steel or carbon steel, brass, phosphor bronze, zirconium copper alloy, beryllium copper, iron nickel, nichrome, nickel titanium, kanthal, hastelloy, and rhenium tungsten, and the like).

The metal wire may have a surface that is coated with a carbon material. Examples of the carbon material coating the metal wire include amorphous carbons (for example, carbon black, activated carbon, hard carbon, soft carbon, mesoporous carbon, carbon fiber, and the like), graphite, fullerene, graphene, carbon nanotube, and the like.

The linear body including carbon nanotubes (hereinafter also referred to as “carbon nanotube linear body”) is a linear body that includes carbon nanotubes as a conductive material.

The carbon nanotube linear body can be obtained by drawing carbon nanotubes from an end of a carbon nanotube forest (a grown form of a plurality of carbon nanotubes grown on a substrate so that the carbon nanotubes are oriented in a vertical direction with respect to the substrate) to form sheets, bundling the drawn carbon nanotube sheets, and then spinning the bundle of carbon nanotubes.

According to this manufacturing method, carbon nanotube linear bodies with high purity can be obtained.

Additionally, in this manufacturing method, ribbon-shaped carbon nanotube linear bodies are obtained when the carbon nanotubes are not twisted in the spinning process, and string-shaped linear bodies are obtained when the carbon nanotubes are twisted in the process. The ribbon-shaped carbon nanotube linear bodies are linear bodies having carbon nanotubes that are not twisted.

The carbon nanotube linear bodies can also be obtained by a method such as spinning from a dispersion liquid of the carbon nanotubes. The carbon nanotube linear bodies can be manufactured by the spinning method disclosed in, for example, US Patent Application Publication No. 2013/0251619 (Japanese Patent Application Publication No. 2012-126635).

The carbon nanotube linear bodies may be linear bodies in which two or more carbon nanotube linear bodies are woven together. The carbon nanotube linear bodies also may be linear bodies including carbon nanotubes in combination with another conductive material (hereinafter also referred to as “composite linear bodies”).

Examples of the composite linear bodies include: (1) a composite linear body obtained by depositing an elemental metal or metal alloy on a surface of a forest, sheets or a bundle of carbon nanotubes, or a spun linear body through a method such as vapor deposition, ion plating, sputtering or wet plating in the process of manufacturing a carbon nanotube linear body obtained by drawing carbon nanotubes from an end of the carbon nanotube forest to form the sheets, bundling the drawn carbon nanotube sheets and then spinning the bundle of the carbon nanotubes; (2) a composite linear body obtained by spinning a bundle of carbon nanotubes with a linear body or composite linear body of an elemental metal or metal alloy; (3) a composite linear body obtained by weaving a carbon nanotube linear body or a composite linear body with a linear body or composite linear body of an elemental metal or metal alloy; and the like.

Note that, for the composite linear body described in (2) above, a metal may be deposited on the carbon nanotubes in a manner similar to the composite linear body described in (1) above. For the composite linear body described in (3) above, which is a composite linear body in which two linear bodies are woven together, three or more of carbon nanotube linear bodies, or linear bodies or composite linear bodies of an elemental metal or metal alloy may be woven together provided that at least one of linear bodies or composite linear bodies of an elemental metal or metal alloy is included therein.

Examples of the metal constituting the composite linear bodies include elemental metals such as gold, silver, copper, iron, aluminum, nickel, chrome, tin, zinc, and the like; and alloys containing at least one of these elemental metals (for example, a copper-nickel-phosphorus alloy, a copper-iron-phosphorus-zinc alloy, and the like).

Examples of the string of the linear body obtained by applying a conductive coating to a string include strings spun from a resin such as a nylon resin or polyester resin, and the like.

Examples of the conductive coating include metal coatings, conductive polymer coatings, carbon material coatings, and the like. The conductive coating can be formed by plating, vapor deposition, or the like. With the linear bodies obtained by applying the conductive coating to the string, the flexibility of the strings is maintained and, at the same time, excellent conductivity is obtained.

Among the conductive linear bodies, the metal wire linear body is preferable.

A wiring sheet for three-dimensional molding having a lower resistance value is easier to obtain as a result of using the metal wire linear body. Additionally, when using the wiring sheet for three-dimensional molding as a heat-generating element, a wiring sheet for three-dimensional molding including the metal wire linear body is preferable as the metal wire linear body has a tendency to generate heat quickly.

### Pseudo-Sheet Structure

The pseudo-sheet structure includes the plurality of conductive linear bodies arranged at an interval. That is, the pseudo-sheet structure is an aggregation of the plurality of conductive linear bodies.

The number of the conductive linear bodies included in the pseudo-sheet structure is two or more, is preferably from 3 to 100, and is more preferably from 4 to 80.

When the number of the conductive linear bodies included in the pseudo-sheet structure is three or more, the conductive linear bodies may be arranged at a regular interval, or may be arranged at irregular intervals.

The interval between the conductive linear bodies is preferably from 0.1 to 100 mm, is more preferably from 1 to 80 mm, and is even more preferably from 2 to 50 mm.

Provided that the interval between the conductive linear bodies is within these ranges, the conductive linear bodies will be densely packed to some extent and, as a result, the resistance of the pseudo-sheet structure can be maintained at a low level. Additionally, when using the wiring sheet for three-dimensional molding as a heat-generating element, a wiring sheet for three-dimensional molding in which the temperature rises in a more uniform manner can be more easily obtained.

The interval between the conductive linear bodies can be calculated by observing the conductive linear bodies of the pseudo-sheet structure using a digital microscope.

A thickness (T₃) of the pseudo-sheet structure is preferably from 7 to 75 μm, more preferably from 8 to 60 μm, and even more preferably from 12 to 40 μm.

When the shapes of the cross-sections of the plurality of conductive linear bodies of the pseudo-sheet structure are all a circular shape having the same diameter, the diameter of the cross-section of these conductive linear bodies can be regarded as the thickness (T₃) of the pseudo-sheet structure. Additionally, when the shapes of the cross-sections of the plurality of conductive linear bodies are all circular and the diameters of the cross-section of these conductive linear bodies are not the same, the largest diameter among the diameters of the cross-sections of these conductive linear bodies can be regarded as the thickness (T₃) of the pseudo-sheet structure.

Moreover, the cross-section of the wiring sheet for three-dimensional molding may be observed using a digital microscope and, assuming a parallelogram, that includes the plurality of conductive linear bodies, of which an upper side and a lower side are parallel, and for which the area is the smallest, a height (distance from the upper side to the lower side) of that parallelogram may be regarded as the thickness (T₃) of the pseudo-sheet structure.

### Embedding Layers

The wiring sheet for three-dimensional molding of the present disclosure includes two embedding layers. Note that, in the present description, when the wiring sheet for three-dimensional molding is placed horizontally, the embedding layer position on the lower side is referred to as the “first embedding layer”, and the embedding layer positioned on the upper side is referred to as the “second embedding layer.”

The pseudo-sheet structure is sandwiched between the first embedding layer and the second embedding layer. The pseudo-sheet structure is stably fixed due to the wiring sheet for three-dimensional molding being provided with such a layered structure.

The storage shear modulus at 23° C. of the first embedding layer is from 1.0×10⁴ to 3.0×10⁶ Pa, is more preferably from 2.0×10⁴ to 3.0×10⁶ Pa, and is even more preferably from 5.0×10⁴ to 3.0×10⁵ Pa. The storage shear modulus at 23° C. of the second embedding layer is 1.0×10⁴ to 3.0×10⁶ Pa, is more preferably from 2.0×10⁴ to 3.0×10⁶ Pa, and is even more preferably from 5.0×10⁴ to 3.0×10⁵ Pa.

The storage shear modulus at 23° C. of the first embedding layer and the second embedding layer can be measured by the method described in the examples.

Due to the storage shear modulus at 23° C. of the first embedding layer and the second embedding layer being in the range described above, it is possible to obtain a wiring sheet for three-dimensional molding in which the conductive linear bodies are reliably fixed at the time of three-dimensional molding processing and in which appearance defect problems are less likely to occur after the three-dimensional molding processing.

That is, the embedding layers deform relatively easily at temperatures near room temperature and, as such, the conductive linear bodies can be sufficiently embedded and reliably fixed. In a wiring sheet in which the conductive linear bodies are sufficiently embedded in the embedding layers, the conductive linear bodies are less likely to shift when carrying out three-dimensional molding processing, and traces of the conductive linear bodies are not conspicuous.

The storage shear modulus at 23° C. of the embedding layers can be appropriately controlled using techniques known in the field of adhesives, such as adjusting the molecular weight of the resin component of the embedding layers, forming a cross-linked structure, and the like.

A thickness (T₁) of the first embedding layer is preferably from 3 to 200 μm, is more preferably from 4 to 150 μm, and is even more preferably from 5 to 100 μm.

A thickness (T₂) of the second embedding layer is preferably from 3 to 200 μm, is more preferably from 4 to 150 μm, and is even more preferably from 5 to 100 μm.

The first embedding layer and the second embedding layer may have the same composition, or may have different compositions. From the perspective of being able to efficiently manufacture the wiring sheet for three-dimensional molding, it is preferable that the first embedding layer and the second embedding layer have the same composition.

It is preferable that the first embedding layer and the second embedding layer are curable. As described above, the storage shear modulus at 23° C. of the embedding layers is a relatively low value and, thus, the embedding layers deform easily. Therefore, a problem of the final product, after the three-dimensional molding processing, easily deforming may occur.

When the first embedding layer and the second embedding layer are curable, deformation in the final product can be suppressed by curing these layers after the three-dimensional molding processing.

The first embedding layer and the second embedding layer can be efficiently formed by using an adhesive as a raw material composition.

The raw material composition used in the forming of the embedding layers is not particularly limited provided that embedding layers having the storage shear modulus described above can be formed.

Examples of the raw material composition include acrylic compositions (compositions containing acrylic polymers), phenoxy-based compositions (compositions containing phenoxy resins), urethane-based compositions (compositions containing urethane-based polymers), rubber-based compositions (compositions containing rubber-based polymers), polyester-based compositions (compositions containing polyester-based polymers), silicone-based compositions (compositions containing silicone-based polymers), polyvinyl ether compositions (compositions containing polyvinyl ether polymers), and the like.

Among these, acrylic compositions and phenoxy-based compositions are preferable.

Examples of the acrylic compositions include resin compositions containing an acrylic polymer containing a repeating unit derived from an alkyl (meth)acrylate having a linear alkyl group or a branched alkyl group, and/or an acrylic polymer containing a repeating unit derived from a (meth)acrylate having a cyclic structure. In this description, the term “(meth)acrylate” is used to refer to both “acrylate” and “methacrylate.”

The acrylic polymer may be a homopolymer or a copolymer. When the acrylic polymer is a copolymer, the mode of copolymerization is not particularly limited. The acrylic copolymer may be any of a block copolymer, a random copolymer, or a graft copolymer.

Among these, the acrylic polymer is preferably an acrylic copolymer including a repeating unit (a1) derived from an alkyl (meth)acrylate (a1′) having a chain alkyl group having 1 to 20 carbon atoms (hereinafter sometimes referred to as “monomer (a1′)), and a repeating unit (a2) derived from a functional group-containing monomer (a2′) (hereinafter sometimes referred to as “monomer (a2′)).

Note that this acrylic copolymer may further include a repeating unit (a3) derived from another monomer (a3′) other than the monomer (a1′) and the monomer (a2′).

From the perspective of enhancing adhesive characteristics, the number of carbons of the chain alkyl group of the monomer (a1′) is preferably from 1 to 12, is more preferably from 4 to 8, and is even more preferably from 4 to 6.

Examples of the monomer (a1′) include methyl (meth)acrylate, ethyl (meth)acrylate, propyl (meth)acrylate, n-butyl (meth)acrylate, 2-ethylhexyl (meth)acrylate, lauryl (meth)acrylate, tridecyl (meth)acrylate, stearyl (meth)acrylate, and the like. Among these monomers (a1′), butyl (meth)acrylate and 2-ethylhexyl (meth)acrylate are preferable, and butyl (meth)acrylate is more preferable.

A single type of the monomer (a1′) can be used, or two or more types of the monomer (a1′) can be combined and used.

A content of the repeating unit (a1) relative to all repeating units of the acrylic copolymer is preferably from 50 to 99.5 mass %, is more preferably from 55 to 99 mass %, is even more preferably from 60 to 97 mass %, and is yet even more preferably from 65 to 95 mass %.

Examples of the monomer (a2′) include hydroxy group-containing monomers, carboxy group-containing monomers, epoxy group-containing monomers, amino group-containing monomers, cyano group-containing monomers, keto group-containing monomers, alkoxysilyl group-containing monomers, and the like. Among these monomers (a2′), hydroxy group-containing monomers and carboxy group-containing monomers are preferable.

Examples of the hydroxy group-containing monomers include 2-hydroxyethyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, and the like.

Examples of the carboxy group-containing monomers include (meth)acrylic acid, maleic acid, fumaric acid, itaconic acid, and the like, of which (meth)acrylic acid is preferable.

Examples of the epoxy group-containing monomers include glycidyl (meth)acrylate and the like.

Examples of the amino group-containing monomers include diaminoethyl (meth)acrylate and the like.

Examples of the cyano group-containing monomers include acrylonitrile and the like.

A single type of the monomer (a2′) can be used, or two or more types of the monomer (a2′) can be combined and used.

A content of the repeating unit (a2) relative to all repeating units of the acrylic copolymer is preferably from 0.1 to 50 mass %, is more preferably from 0.5 to 40 mass %, is even more preferably from 1.0 to 30 mass %, and is yet even more preferably from 1.5 to 20 mass %.

Examples of the monomer (a3′) include (meth)acrylates having a cyclic structure (for example, cyclohexyl (meth)acrylate, benzyl (meth)acrylate, isobornyl (meth)acrylate, dicyclopentanyl (meth)acrylate, dicyclopentenyl (meth)acrylate, dicyclopentenyloxyethyl (meth)acrylate, imide (meth)acrylate, and acryloylmorpholine, and the like), vinyl acetate, styrene, and the like.

A single type of the monomer (a3′) can be used, or two or more types of the monomer (a3′) can be combined and used.

A content of the repeating unit (a3) relative to all repeating units of the acrylic copolymer is preferably from 0 to 40 mass %, is more preferably from 0 to 30 mass %, is even more preferably from 0 to 25 mass %, and is yet even more preferably from 0 to 20 mass %.

A weight average molecular weight (Mw) of the acrylic polymer is typically from 50,000 to 800,000, is preferably from 80,000 to 500,000, and is more preferably from 100,000 to 450,000. The storage shear modulus of the embedding layers may be appropriate due to the weight average molecular weight of the acrylic polymer being in the range described above.

The weight average molecular weight (Mw) of the acrylic polymer can be calculated as a standard polystyrene conversion value by performing gel permeation chromatography (GPC) using tetrahydrofuran (THF) as a solvent.

A content of the acrylic polymer included in the acrylic composition is, of the effective components of the acrylic composition, typically from 60 to 99.9 mass %, and is preferably from 80 to 99.9 mass %.

In the present specification, the term “effective components” means the components in the composition, excluding the solvent.

The acrylic polymer may be cross-linked by a cross-linking agent. Examples of the cross-linking agent include epoxy cross-linking agents, isocyanate cross-linking agents, aziridine cross-linking agents, metal chelate cross-linking agents, and the like. When cross-linking the acrylic copolymer, the functional group derived from the monomer (a2′) can be used as a cross-linking point that reacts with the cross-linking agent.

The storage shear modulus of the embedding layers can be efficiently controlled by cross-linking the acrylic copolymer using the cross-linking agent.

When the acrylic composition contains the cross-linking agent, the content of the cross-linking agent is, of the effective components of the acrylic composition, typically 30 mass % or less, is preferably from 0.1 to 30 mass %, and is more preferably from 0.1 to 15 mass %.

The acrylic composition may contain an energy ray-curable component.

By using an acrylic composition that contains an energy ray-curable component, the curable embedding layers can be efficiently formed.

Examples of the energy ray-curable component include compounds having two or more UV-polymerizable functional groups in one molecule, such as polyfunctional (meth)acrylate compounds and the like, and the like.

Additionally, compounds having a functional group that reacts with the functional group of the monomer (a2′) and an energy ray-polymerizable functional group in one molecule can be used as the energy ray-curable component.

The phenoxy-based composition is a resin composition that contains phenoxy resin as a binder resin.

The phenoxy resin is a polymer whose main chain is a polyaddition structure of an aromatic diol and an aromatic diglycidyl ether. In the present specification, the polymer for which the weight average molecular weight (Mw) is greater than 10,000 is defined as “phenoxy resins.”

Examples of the phenoxy resin include bisphenol A type phenoxy resin, bisphenol F type phenoxy resin, bisphenol A-bisphenol F type phenoxy resin, bisphenol E type phenoxy resin, and the like.

The phenoxy resin can be obtained by a reaction of a bisphenol compound or a biphenol compound with an epihalohydrin such as epichlorohydrin, or a reaction of a bisphenol compound or a biphenol compound with a liquid epoxy resin.

A single type of the phenoxy resin can be used, or two or more types of the phenoxy resin can be combined and used.

A commercially available product can be used as the phenoxy resin. Examples of the commercially available product include PKHC, PKHH, and PKHJ (trade names, all manufactured by Tomoe Engineering Co.); Epicote 4250, Epicote 1255HX30, and Epicote 5580BPX40 (trade names, all manufactured by Nippon Kayaku Co., Ltd.); YP-50, YP50S, YP-55, and YP-70 (trade names, all manufactured by Nippon Steel Chemical & Material Co. Ltd.); JER 1256, 4250, YX6954BH30, YX7200B35, and YL7290BH30 (trade names, all manufactured by Mitsubishi Chemical Corporation); and the like.

A weight average molecular weight (Mw) of the phenoxy resin is typically from 10,000 to 200,000, is preferably from 20,000 to 100,000, and is more preferably from 30,000 to 80,000. The storage shear modulus of the embedding layers may be appropriate due to the weight average molecular weight of the phenoxy resin being in the range described above.

The weight average molecular weight (Mw) of the phenoxy resin can be calculated as a standard polystyrene conversion value by performing gel permeation chromatography (GPC) using tetrahydrofuran (THF) as a solvent.

A content of the phenoxy resin included in the phenoxy-based composition is, of the effective components of the phenoxy-based composition, typically from 20 to 90 mass %, and is preferably from 30 to 80 mass %.

The phenoxy-based composition may contain an epoxy resin. Note that, in the present specification, resins for which the weight average molecular weight (Mw) is 10,000 or less are defined as “epoxy resins”, and are differentiated from the “phenoxy resins.”

Examples of the epoxy resin include aliphatic epoxy compounds (excluding alicyclic epoxy compounds), aromatic epoxy compounds, alicyclic epoxy compounds, and the like.

Examples of the aliphatic epoxy compound include 1,4-butanediol diglycidyl ether, neopentyl glycol diglycidyl ether, triglycidyl ether of glycerin, triglycidyl ether of trimethylolpropane, tetraglycidyl ether of sorbitol, hexaglycidyl ether of dipentaerythritol, diglycidyl ether of polyethylene glycol, diglycidyl ether of polypropylene glycol, and the like.

Examples of the aromatic epoxy compound include bisphenol A, bisphenol F, glycidyl etherified products of compounds obtained by adding alkylene oxide to these bisphenol compounds, or epoxy novolak resins; polyglycidyl etherified products of aromatic compounds having two or more phenolic hydroxyl groups such as resorcinol, hydroquinone and catechol; glycidyl etherified products of aromatic compounds having two or more alcoholic hydroxyl groups such as phenyldimethanol, phenyldiethanol, and phenyldibutanol; glycidyl esters of polybasic acid aromatic compounds having two or more carboxylic acids such as phthalic acid, terephthalic acid, and trimellitic acid; and the like.

Examples of the alicyclic epoxy compound include polyglycidyl etherified products of a polyhydric alcohol having at least one or more alicyclic structures such as dicyclopentadiene dimethanol diglycidyl ether, a hydrogenated product of bisphenol A, and the like; and cycloalkene oxide compounds such as cyclohexene oxide and cyclopentene oxide-containing compounds obtained by epoxidizing, with an oxidizing agent, a cyclohexene ring-containing compound or a cyclopentene ring-containing compound.

A single type of the epoxy resin can be used, or two or more types of the epoxy resin can be combined and used.

A molecular weight of the epoxy resin is typically from 100 to 5,000, and is preferably from 200 to 4,000.

When the phenoxy-based composition contains the epoxy resin, a content of the epoxy resin is, of the effective components of the phenoxy-based composition, typically 75 mass % or less, is preferably from 5 to 75 mass %, and is more preferably from 10 to 50 mass %.

When the raw material composition contains a curable component, it is preferable that the raw material composition contains a polymerization initiator.

For example, in a raw material composition that contains a cationic polymerizable compound such as an epoxy compound or the like, the curable embedding layers can be more efficiently formed by compounding a cationic polymerization initiator.

The cationic polymerization initiator compound is preferably a photocationic polymerization initiator. This is because, when using a thermal cationic polymerization initiator, the curing reaction may progress during the three-dimensional molding.

On this point, by using a photocationic polymerization initiator, the curing reaction can be caused to progress after the end of the three-dimensional molding, without causing the curing reaction to progress at the time of the three-dimensional molding.

The photocationic polymerization initiator is a compound that produces cation species as a result of being irradiated with ultraviolet rays, and initiates a curing reaction of the cationic polymerizable compound. The photocationic polymerization initiator is constituted from a cationic part that absorbs ultraviolet light and an anionic part that is an acid source.

Examples of the photocationic polymerization initiator include sulfonium salt compounds, iodonium salt compounds, phosphonium salt compounds, ammonium salt compounds, diazonium salt compounds, selenium salt compounds, oxonium salt compounds, and the like. Among these, since compatibility with other components is excellent, the sulfonium salt compounds are preferable, and aromatic sulfonium salt compounds having an aromatic group are more preferable.

Examples of the sulfonium salt compounds include triphenylsulfonium hexafluorophosphate, triphenylsulfonium hexafluoroantimonate, triphenylsulfonium tetrakis(pentafluorophenyl)borate, 4,4′-bis[diphenylsulfonio]diphenylsulfide-bishexafluorophosphate, 4,4′-bis[di(β-hydroxyethoxy)phenylsulfonio]diphenylsulfide-bishexafluoroantimonate, 7-[di(p-toluyl)sulfonio]-2-isopropylthioxanthone hexafluorophosphate, 7-[di(p-toluyl)sulfonio]-2-isopropylthioxanthone hexafluoroantimonate, 7-[di(p-toluyl)sulfonio]-2-isopropyltetrakis(pentafluorophenyl)borate, phenylcarbonyl-4′-diphenylsulfonio-diphenylsulfide-hexafluorophosphate, phenylcarbonyl-4′-diphenylsulfonio-diphenylsulfide-hexafluoroantimonate, 4-tert-butylphenylcarbonyl-4′-diphenylsulfonio-diphenylsulfide-hexafluorophosphate, 4-tert-butylphenylcarbonyl-4′-diphenylsulfonio-diphenylsulfide-hexafluoroantimonate, 4-tert-butylphenylcarbonyl-4′-diphenylsulfonio-diphenylsulfide-tetrakis(pentafluorophenyl)borate, 4-(phenylthio)phenyldiphenylsulfonium hexafluoroantimonate, 4-(phenylthio)phenyldiphenylsulfonium hexafluorophosphate, 4-{4-(2-chlorobenzoyl)phenylthio}phenylbis(4-fluorophenyl)sulfonium hexafluoroantimonate, a halide of thiophenyldiphenylsulfonium hexafluoroantimonate, 4,4′,4″-tri(β-hydroxyethoxyphenyl)sulfonium hexafluoroantimonate, 4,4′-bis[diphenylsulfonio]diphenylsulfide-bishexafluoroantimonate, diphenyl[4-(phenylthio)phenyl]sulfonium trifluorotrispentafluoroethyl phosphate, tris[4-(4-acetylphenylsulfanyl)phenyl]sulfonium tris[(trifluoromethyl)sulfonyl]methanide, salts in which the cation portion is 4-(phenylthio)phenyldiphenylsulfonium and the anion portion is a phosphorus-based anion to which fluorine and a perfluoroalkyl group are added, and the like.

Examples of the iodonium salt compounds include diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, (tricumyl)iodonium tetrakis(pentafluorophenyl)borate, and the like.

Examples of the phosphonium salt compounds include tri-n-butyl(2,5-dihydroxyphenyl)phosphonium bromide, hexadecyltributylphosphonium chloride, and the like.

Examples of the ammonium salt compounds include benzyltrimethylammonium chloride, phenyltributylammonium chloride, benzyltrimethylammonium bromide, and the like.

A single type of the photocationic polymerization initiator can be used, or two or more types of the photocationic polymerization initiator can be combined and used.

A commercially available product can be used as the photocationic polymerization initiator. Examples of the commercially available product include Cyracure UVI-6970, Cyracure UVI-6974, Cyracure UVI-6990, and Cyracure UVI-950 (manufactured by Union Carbide Corporation); Irgacure 250, Irgacure 261, and Irgacure 264 (manufactured by Ciba Specialty Chemicals); SP-150, SP-151, SP-170, and Optomer SP-171 (manufactured by ADEKA); CG-24-61 (manufactured by Ciba Specialty Chemicals); DAICAT II (manufactured by Daicel); UVAC1590 and UVAC1591 (manufactured by Daicel-Cytec Co., Ltd.); CI-2064, CI-2639, CI-2624, CI-2481, CI-2734, CI-2855, CI-2823, CI-2758, and CIT-1682 (manufactured by Nippon Soda Co., Ltd.); PI-2074 (manufactured by Rhodia); FFC509 (manufactured by 3M); BBI-102, BBI-101, BBI-103, MPI-103, TPS-103, MDS-103, DTS-103, NAT-103, and NDS-103 (manufactured by Midori Kagaku Co., Ltd.); CD-1010, CD-1011, and CD-1012 (manufactured by Sartomer); CPI-100P, CPI-101A, CPI-200K, and CPI-310B (manufactured by San-Apro Co., Ltd.); San-Aid SI-60, San-Aid SI-80, San-Aid SI-100, San-Aid SI-110, and San-Aid SI-150 (manufactured by Sanshin Chemical Industry Co., Ltd.); and the like.

When the raw material composition contains the photocationic polymerization initiator, a content of the photocationic polymerization initiator relative to 100 parts by mass of the cationic polymerizable compound is typically from 0.1 to 10 parts by mass, is preferably from 0.3 to 8 parts by mass, and is more preferably from 0.5 to 6 parts by mass.

The raw material composition used in the forming of the embedding layers may contain additives such as tackifiers, silane coupling agents, antistatic agents, stabilizers, antioxidants, plasticizers, lubricants, color pigments, and the like, and solvents in ranges that do not inhibit the effects of the present disclosure.

Contents of these additives and solvents can be appropriately determined in accordance with the purpose thereof.

The forming method of the embedding layers is not particularly limited. For example, the embedding layers can be formed by applying the raw material composition to a substrate or a release sheet, and drying the obtained coating.

The substrate or the release sheet may be a constituent that ultimately forms a resin layer of the wiring sheet for three-dimensional molding of the present disclosure.

### Resin Layer

The wiring sheet for three-dimensional molding of the present disclosure may include resin layers adjacent to the embedding layers. In the present specification, the resin layer adjacent to the first embedding layer is referred to as the “first resin layer”, and the resin layer adjacent to the second embedding layer is referred to as the “second resin layer.”

Note that, in the present disclosure, the term “resin layer” is not limited to members that also exist after the three-dimensional molding of the wiring sheet for three-dimensional molding is ended and the product is obtained, that is, members (substrates) provided inseparable from the embedding layers, but also includes members (for example, release sheets, protection sheets, process sheets, and the like) that exist at the time of manufacture and the time of storage of the wiring sheet for three-dimensional molding and are removed during the product manufacturing process.

The resin layer has roles related to maintaining the shape and enhancing the impact resistance of the wiring sheet for three-dimensional molding.

A thickness of the resin layer is typically from 10 to 500 μm, and is preferably from 20 to 300 μm.

A resin film is preferably used as the resin layer.

Examples of the resin film include polymethyl methacrylate resin film, polyethylene film, polypropylene film, polybutene film, polybutadiene film, polymethylpentene film, polyvinyl chloride film, vinyl chloride copolymer film, polyethylene terephthalate film, polyethylene naphthalate film, polybutylene terephthalate film, polyurethane film, ethylene vinyl acetate copolymer film, ionomer resin film, ethylene/(meth)acrylic acid copolymer film, ethylene/(meth)acrylic acid ester copolymer film, polystyrene film, polycarbonate film, polyether ether ketone film, polyphenylene sulfide film, polyvinylidene fluoride film, polytetrafluoroethylene film, silicone film, polyimide film, and the like.

When the resin layer is to be removed during the product manufacturing process, it is preferable that the surface of the side of the resin layer that contacts the embedding layer is releasable.

A member obtained by providing a release layer on a surface of the resin film is preferably used as such a resin layer.

The release layer can be formed using a known release agent.

A thickness of the release layer is not particularly limited, but is typically from 0.01 to 2.0 μm, and is preferably from 0.03 to 1.0 μm.

### Wiring Sheet for Three-Dimensional Molding

When the thickness of the first embedding layer is T₁, the thickness of the second embedding layer is T₂, and the thickness of the pseudo-sheet structure is T₃, the wiring sheet for three-dimensional molding of the present disclosure satisfies the following equation:

1<(T₁+T₂)/T₃≤10 Equation 3

The wiring sheet for three-dimensional molding of the present disclosure satisfies the equation described above and, as such, appearance defect problems are less likely to occur after the three-dimensional molding processing.

The value of (T₁+T₂)/T₃ is preferably greater than 1 and 8 or less, and is more preferably greater than 1 and 5 or less.

The manufacturing method of the wiring sheet for three-dimensional molding of the present disclosure is not particularly limited.

For example, the wiring sheet for three-dimensional molding can be obtained by preparing two embedding layers, embedding the pseudo-sheet structure in one of the embedding layers, and affixing the other embedding layer thereon.

The wiring sheet for three-dimensional molding of the present disclosure is preferably used as a manufacturing material for a heat-generating element that has a predetermined shape.

Examples of uses of the heat-generating element includes defoggers, defrosters, and the like.

### EXAMPLES

In the following, examples are used to describe the present disclosure in further detail. However, it should be noted that the present disclosure is not limited in any way to the following examples.

Note that, in the following, the “resin layer forming film” is sometimes referred to as the “resin layer”, and the “embedding layer forming adhesive sheet” is sometimes referred to as the “embedding layer.”

### Compounds and Members Used in the Examples

Acrylic copolymer (A): Acrylic copolymer obtained using n-butyl acrylate/acrylic acid=90.0/10.0 (mass ratio) as raw material monomers, weight average molecular weight (Mw): 410,000
Isocyanate compound (B): Trimethylolpropane modified tolylene diisocyanate, manufactured by ToyoChem Co., Ltd, trade name: BHS8515
Phenoxy resin (C): Manufactured by Mitsubishi Chemical Corporation, trade name: YX7200B35
Epoxy compound (D): Epoxy resin having an oxyalkylene group [manufactured by Mitsubishi Chemical Corporation, trade name: YX7400, cyclic ether equivalent: 440 g/eq, (liquid at 25° C.)]
Epoxy compound (E): Hydrogenated bisphenol A type epoxy resin [manufactured by Mitsubishi Chemical Corporation, trade name: YX8000, cyclic ether equivalent: 205 g/eq, liquid at 25° C.]
Photocationic polymerization initiator (F): 4-(Phenylthio)phenyldiphenylsulfonium hexafluorophosphate [manufactured by San-Apro Ltd., trade name: CPI-100P]
Thermal cationic polymerization initiator (G): Manufactured by Sanshin Chemical Industry Co., Ltd., trade name: SI-B3
Resin layer (H): PMMA film [Manufactured by Sumika Acryl Co., Ltd, trade name: TECHNOLLOY S000, thickness: 200 μm]

### Manufacturing Example 1

100 parts by mass of the acrylic copolymer (A), 0.3 parts by mass of the isocyanate compound (B) (effective component), and toluene were mixed. Thus, a raw material composition (I) having an effective component concentration of 25 mass % was obtained.

### Manufacturing Example 2

The raw material composition (I) obtained in Manufacturing Example 1 was applied to a release treatment surface of a release film (manufactured by Lintec Corporation, trade name: SP-PET752150), and the obtained coating was dried for two minutes at 100° C. to form an embedding layer (Ia) having a thickness of 20 μm. The release treatment surface of another release film (manufactured by Lintec Corporation, trade name: SP-PET381031) was affixed to this embedding layer (Ia), thereby fabricating an embedding layer (Ia) with release film.

### Manufacturing Example 3

With the exception of changing the thickness of the embedding layer to 15 μm, an embedding layer (Ib) with release film was fabricated in the same manner as in Manufacturing Example 2.

### Manufacturing Example 4

With the exception of changing the thickness of the embedding layer to 10 μm, an embedding layer (Ic) with release film was fabricated in the same manner as in Manufacturing Example 2.

### Manufacturing Example 5

With the exception of changing the amount of the isocyanate compound (B) to 5 parts by mass (effective component) in Manufacturing Example 1, a raw material composition (II) was obtained in the same manner as in Manufacturing Example 1.

### Manufacturing Example 6

The raw material composition (II) obtained in Manufacturing Example 5 was applied to a release treatment surface of a release film (manufactured by Lintec Corporation, trade name: SP-PET752150), and the obtained coating was dried for two minutes at 100° C. to form an embedding layer (IIa) having a thickness of 30 μm. The release treatment surface of another release film (manufactured by Lintec Corporation, trade name: SP-PET381031) was affixed to this embedding layer (IIa), thereby fabricating an embedding layer (IIa) with release film.

### Manufacturing Example 7

With the exception of changing the thickness of the embedding layer to 20 μm, an embedding layer (IIb) with release film was fabricated in the same manner as in Manufacturing Example 6.

### Manufacturing Example 8

With the exception of changing the thickness of the embedding layer to 10 μm, an embedding layer (IIc) with release film was fabricated in the same manner as in Manufacturing Example 6.

### Manufacturing Example 9

With the exception of changing the thickness of the embedding layer to 5 μm, an embedding layer (IId) with release film was fabricated in the same manner as in Manufacturing Example 6.

### Manufacturing Example 10

100 parts by mass of the phenoxy resin (C), 60 parts by mass of the epoxy compound (D), 2 parts by mass of the photocationic polymerization initiator (F), and methyl ethyl ketone were mixed. Thus, a raw material composition (III) having an effective component concentration of 50 mass % was obtained.

### Manufacturing Example 11

The raw material composition (III) obtained in Manufacturing Example 10 was applied to a release treatment surface of a release film (manufactured by Lintec Corporation, trade name: SP-PET752150), and the obtained coating was dried for two minutes at 100° C. to form an embedding layer (IIIa) having a thickness of 25 μm. The release treatment surface of another release film (manufactured by Lintec Corporation, trade name: SP-PET381031) was affixed to this embedding layer (IIIa), thereby fabricating an embedding layer (IIIa) with release film.

### Manufacturing Example 12

With the exception of changing the thickness of the embedding layer to 20 μm, an embedding layer (IIIb) with release film was fabricated in the same manner as in Manufacturing Example 11.

### Manufacturing Example 13

The embedding layer (IIIa) with release film obtained in Manufacturing Example 11 was irradiated with UV light using a high-pressure mercury lamp (manufactured by Eye Graphics Co., Ltd.) under the conditions of an illuminance of 200 mW/cm² and an integrated light amount of 1000 mJ/cm². Thus, an embedding layer (IIIc) with release film was obtained.

### Manufacturing Example 14

The embedding layer (IIIb) with release film obtained in Manufacturing Example 12 was irradiated with UV light using a high-pressure mercury lamp (manufactured by Eye Graphics Co., Ltd.) under the conditions of an illuminance of 200 mW/cm² and an integrated light amount of 1000 mJ/cm². Thus, an embedding layer (IIId) with release film was obtained.

### Manufacturing Example 15

100 parts by mass of the phenoxy resin (C), 200 parts by mass of the epoxy compound (E), 8 parts by mass of the thermal cationic polymerization initiator (G), and methyl ethyl ketone were mixed. Thus, a raw material composition (IV) having an effective component concentration of 50 mass % was obtained.

### Manufacturing Example 16

The raw material composition (IV) obtained in Manufacturing Example 15 was applied to a release treatment surface of a release film (manufactured by Lintec Corporation, trade name: SP-PET752150), and the obtained coating was dried for two minutes at 100° C. to form an embedding layer (IVa) having a thickness of 20 μm. The release treatment surface of another release film (manufactured by Lintec Corporation, trade name: SP-PET381031) was affixed to this embedding layer (IVa), thereby fabricating an embedding layer (IVa) with release film.

### Measurement of Storage Shear Modulus (G′)

The storage shear modulus (G′) was measured in accordance with HS K7244-6, using a viscoelasticity measuring device (manufactured by Anton paar, trade name: MCR302), by a torsional shear method under the conditions of a frequency of 1 Hz, a test starting temperature of 0° C., a test ending temperature of 120° C., and a temperature raise speed of 3° C./minute.

Note that measurement samples were obtained by mutually different methods in accordance with the characteristics of the raw material composition. Detail are given below.

### Raw Material Composition (I)

A plurality of the embedding layer (Ia) with release film obtained in Manufacturing Example 2 was prepared, the release films thereof were peeled off and, then, the embedding layer (Ia) was laminated. Thus, a laminate having a thickness of about 0.5 mm was obtained.

Next, the obtained laminate was seasoned by storing in an environment with a temperature of 23° C. and relative humidity of 50% for one week and, then, the laminate was punched out into a cylindrical shape having a diameter of 8 mm (height: 0.5 mm) and this cylindrical laminate was used as the measurement sample.

### Raw Material Composition (II)

A plurality of the embedding layer (IIa) with release film obtained in Manufacturing Example 6 was prepared, the release films thereof were peeled off and, then, the embedding layer (IIa) was laminated. Thus, a laminate having a thickness of about 0.5 mm was obtained.

Next, the obtained laminate was seasoned by storing in an environment with a temperature of 23° C. and relative humidity of 50% for one week and, then, the laminate was punched out into a cylindrical shape having a diameter of 8 mm (height: 0.5 mm) and this cylindrical laminate was used as the measurement sample.

### Raw Material Composition (III)

A plurality of the embedding layer (IIIa) with release film obtained in Manufacturing Example 10 was prepared, the release films thereof were peeled off and, then, the embedding layer (IIIa) was laminated. Thus, a laminate having a thickness of about 0.5 mm was obtained.

Note that, regarding the raw material composition (III), two of the laminates were fabricated. One laminate was punched out into a cylindrical shape having a diameter of 8 mm (height: 0.5 mm) and this cylindrical laminate was used as the measurement sample.

The other laminate was irradiated with UV light using a high-pressure mercury lamp (manufactured by Eye Graphics Co., Ltd.) under the conditions of an illuminance of 200 mW/cm² and an integrated light amount of 1000 mJ/cm² and, then, the laminate was punched out into a cylindrical shape having a diameter of 8 mm (height: 0.5 mm) and this cylindrical laminate was used as the measurement sample.

### Raw Material Composition (IV)

A plurality of the embedding layer (IVa) with release film obtained in Manufacturing Example 13 was prepared, the release films thereof were peeled off and, then, the embedding layer (IVa) was laminated. Thus, a laminate having a thickness of about 0.5 mm was obtained.

Next, the obtained laminate was subjected to heat curing at 100° C. for 60 minutes and, then, the laminate was punched out into a cylindrical shape having a diameter of 8 mm (height: 0.5 mm) and this cylindrical laminate was used as the measurement sample.

The compositions of the raw material compositions, the measurement sample preparation conditions, and the measurement results of the storage shear modulus (G′) are illustrated in Table 1.

TABLE 1

| | | | | Measurement | Storage |
|---|---|---|---|---|---|
| | | | | sample | shear |
| | | | | preparation | modulus |
| | Composition | | | conditions | (G′) |
| Raw | Acrylic | Isocyanate | | 23° C. | 1.3 × |
| material | copolymer | compound | | Relative | 10⁵ Pa |
| composition | (A) | (B) | | humidity: | |
| (I) | 100 parts | 0.3 parts | | 50% | |
| Raw | Acrylic | Isocyanate | | 1 hour | 1.8 × |
| material | copolymer | compound | | | 10⁵ Pa |
| composition | (A) | (B) | | | |
| (II) | 100 parts | 5 parts | | | |
| Raw | Phenoxy | Epoxy | Photocationic | | 2.6 × |
| material | resin | compound | polymerization | | 10⁵ Pa |
| composition | (C) | (D) | initiator (F) | UV light | 5.2 × |
| (III) | 100 parts | 60 parts | 2 parts | irradiation | 10⁶ Pa |
| Raw | Phenoxy | Epoxy | Thermal cationic | 100° C. | 2.4 × |
| material | resin | compound | polymerization | 1 hour | 10⁹ Pa |
| composition | (C) | (D) | initiator (G) | | |
| (IV) | 100 parts | 200 parts | 8 parts | | |

### Example 1

The release film on one side of the embedding layer (Ia) with release film (member seasoned by storing for one week in a 23° C., 50% relative humidity environment) obtained in Manufacturing Example 2 was peeled, and the exposed embedding layer (Ia) and the resin layer (H) were affixed to each other by laminating under the conditions of 23° C. and 0.5 MPa. Thus, a laminate having a “resin layer (H)/embedding layer (Ia)/release film” laminated structure was obtained. Next, the release film of this laminate was peeled and removed, and the remaining laminate was wound on a drum member having a rubber outer circumferential surface such that the embedding layer (Ia) was on the outside, and this wound laminate was fixed using double-sided tape.

A silver-plated tungsten wire (diameter: 14 μm, manufactured by Tokusai TungMoly Co., Ltd., product name: Ag (0.1)-TWG, hereinafter referred to as “wire”) was wound on the bobbin and, then, this wire was adhered to the surface of the embedding layer (Ia) positioned near the end of the drum member and then was wound on the drum member while feeding out the wire. Note that, in this process, the wire was wound while vibrating the drum member in a drum axis direction such that the wound wire formed a wave shape.

Thus, a plurality of wires was provided on the surface of the embedding layer (Ia), and a pseudo-sheet structure having a thickness of 14 μm was formed in which a plurality of wires is provided at a regular interval. Thus, the embedding layer (Ia) having a pseudo-sheet structure was obtained.

Next, the laminate having the “resin layer (H)/embedding layer (Ia) having a pseudo-sheet structure” laminated structure was cut into a 200 mm×300 mm rectangle (the direction in which the wires extended was the long side). Thus, a manufacturing intermediate of a wiring sheet for three-dimensional molding having a pseudo-sheet structure constituted by 10 wires was fabricated. The wires are provided at a regular interval in this manufacturing intermediate of a wiring sheet for three-dimensional molding, and the interval is 5 mm. Additionally, a wavelength of the wave-shape wires is 5.5 mm, and an amplitude is 1.5 mm.

The release film on one side of the embedding layer (Ia) with release film (member seasoned by storing for one week in a 23° C., 50% relative humidity environment) obtained in Manufacturing Example 2 was peeled, and the exposed embedding layer (Ia) and the embedding layer (Ia) having a pseudo-sheet structure of the “manufacturing intermediate of the wiring sheet for three-dimensional molding” were affixed to each other under the conditions of 23° C. and 0.5 MPa. Thus, a wiring sheet for three-dimensional molding having a “resin layer (H)/embedding layer (Ia)/pseudo-sheet structure/embedding layer (Ia)/release film” laminated structure was obtained.

### Examples 2 to 5, Comparative Examples 1 to 3

With the exception of changing the embedding layers and the resin layer to those illustrated in Table 2, wiring sheets for three-dimensional molding were obtained in the same manner as in Example 1.

Note that the pseudo-sheet structure is omitted from Table 2.

Additionally, for the embedding layers (Ib) and (Ic) and the embedding layers (IIa) to (IId), members seasoned by storing for one week in a 23° C., 50% relative humidity environment were used and, for the embedding layer (IVa), a member subjected to heat curing at 100° C. for 60 minutes was used.

### Three-Dimensional Vacuum Molding (TOM Molding)

The obtained wiring sheet for three-dimensional molding was affixed by TOM molding to an ellipsoidal polycarbonate adherend having a width of 10 cm, a length of 15 cm, and in which the height of a center section is 2 cm.

The TOM molding was carried out at 120° C. using a TOM molder manufactured by SIBE AUTOMATION.

Note that, for the wiring sheets for three-dimensional molding obtained in Examples 1, 4, and 5, and Comparative Example 3, the release film was peeled and removed, the exposed embedding layer and the adherend were stacked so as to contact each other, and the TOM molding was carried out; and for the wiring sheets for three-dimensional molding of Examples 2 and 3, and Comparative Examples 1 and 2, the resin layer (H) and the adherend were stacked so as to contact each other, and the TOM molding was carried out.

The obtained molded products were observed using a digital microscope. Cases in which molding was performed without appearance defects were evaluated as “Good” and cases in which defects in the cavities occurred near the wires were evaluated as “Poor.”

TABLE 2

| | | | | | | Appearance |
|---|---|---|---|---|---|---|
| | | | | | | evaluations |
| | Resin | Embedding | Embedding | Resin | | after TOM |
| | layer | layer | layer | layer | (T₁ + T₂)/T₃ | molding |
| Example 1 | Resin | Embedding | Embedding | Release | 2.86 | Good |
| | layer | layer (Ia) | layer (Ia) | film | | |
| | (H) | Thickness: | Thickness: | | | |
| | | 20 μm | 20 μm | | | |
| | | 1.3 × 10⁵ Pa | 13 × 10⁵ Pa | | | |
| Example 2 | Resin | Embedding | Embedding | Resin | 1.79 | Good |
| | layer | layer (Ib) | layer (Ic) | layer | | |
| | (H) | Thickness: | Thickness: | (H) | | |
| | | 15 μm | 10 μm | | | |
| | | 1.3 × 10⁵ Pa | 1.3 × 10⁵ Pa | | | |
| Example 3 | Resin | Embedding | Embedding | Resin | 3.57 | Good |
| | layer | layer (IIa) | layer (IIb) | layer | | |
| | (H) | Thickness: | Thickness: | (H) | | |
| | | 30 μm | 20 μm | | | |
| | | 1.8 × 10⁵ Pa | 1.8 × 10⁵ Pa | | | |
| Example 4 | Resin | Embedding | Embedding | Release | 2.14 | Good |
| | layer | layer (Ia) | layer (IIc) | film | | |
| | (H) | Thickness: | Thickness: | | | |
| | | 20 μm | 10 μm | | | |
| | | 1.3 × 10⁵ Pa | 1.8 × 10⁵ Pa | | | |
| Example 5 | Resin | Embedding | Embedding | Release | 3.21 | Good |
| | layer | layer (IIIa) | layer (IIIb) | film | | |
| | (H) | Thickness: | Thickness: | | | |
| | | 25 μm | 20 μm | | | |
| | | 2.6 × 10⁵ Pa | 2.6 × 10⁵ Pa | | | |
| Comparative | Resin | Embedding | Embedding | Resin | 2.50 | Poor |
| Example 1 | layer | layer (Ib) | layer (IVa) | layer | | |
| | (H) | Thickness: | Thickness: | (H) | | |
| | | 15 μm | 20 μm | | | |
| | | 1.3 × 10⁵ Pa | 2.4 × 10⁹ Pa | | | |
| Comparative | Resin | Embedding | Embedding | Resin | 0.71 | Poor |
| Example 2 | layer | layer (IId) | layer (IId) | layer | | |
| | (H) | Thickness: | Thickness: | (H) | | |
| | | 5 μm | 5 μm | | | |
| | | 1.8 × 10⁵ Pa | 1.8 × 10⁵ Pa | | | |
| Comparative | Resin | Embedding | Embedding | Release | 3.21 | Poor |
| Example 3 | layer | layer (IIIc) | layer (IIId) | film | | |
| | (H) | Thickness: | Thickness: | | | |
| | | 25 μm | 20 μm | | | |
| | | 5.2 × 10⁶ Pa | 5.2 × 10⁶ Pa | | | |

By using the wiring sheets for three-dimensional molding of Examples 1 to 5, three-dimensional molding processing can be carried out without appearance defects occurring.

However, when using the wiring sheets of Comparative Examples 1 and 3, the elastic modulus of embedded layers is excessively high and, consequently, it was not possible to sufficiently embed the wires, and cavities caused by the wires moving during the three-dimensional molding processing were observed.

Additionally, when using the wiring sheets of Comparative Example 2, the thickness of the embedding layers was insufficient and, consequently, it was not possible to sufficiently embed the wires, and cavities caused by the wires moving during the three-dimensional molding processing were observed.

### REFERENCE SIGNS LIST

100, 200, 300 Wiring sheet for three-dimensional molding
1a, 1b, 1c Conductive linear body
2a, 2b, 2c Pseudo-sheet structure
3a, 3b, 3c First embedding layer
4a, 4b, 4c Second embedding layer
5b, 5c First resin layer
6c Second resin layer

1. A wiring sheet for three-dimensional molding, comprising:
a pseudo-sheet structure including a plurality of conductive linear bodies arranged at an interval;
a first embedding layer; and
a second embedding layer, the pseudo-sheet structure being sandwiched between the first embedding layer and the second embedding layer, wherein
the conductive linear bodies have a wave shape when viewed from above,
a storage shear modulus at 23° C. of each of the first embedding layer and the second embedding layer is from 1.0×10⁴ to 3.0×10⁶ Pa, and
when a thickness of the first embedding layer is T₁, a thickness of the second embedding layer is T₂, and a thickness of the pseudo-sheet structure is T₃, a following equation is satisfied:
1<(T₁+T₂)/T₃≤10. Equation 1

2. The wiring sheet for three-dimensional molding according to claim 1, wherein a shape of a cross-section of each of the conductive linear bodies is a round shape having a diameter of 7 to 75 μm.

3. The wiring sheet for three-dimensional molding according to claim 1, wherein the first embedding layer and the second embedding layer have identical compositions.

4. The wiring sheet for three-dimensional molding according to claim 1, wherein the first embedding layer and the second embedding layer are curable.

5. The wiring sheet for three-dimensional molding according to claim 1, further comprising at least one of a first resin layer adjacent to the first embedding layer and a second resin layer adjacent to the second embedding layer.

6. The wiring sheet for three-dimensional molding according to claim 5, wherein at least one of a surface on a first embedding layer side of the first resin layer and a surface on a second embedding layer side of the second resin layer is releasable.
